(19) United States
(12) Patent Application Publication
(10) Pub. No.: US 2008/0260131 A1
(43) Pub. Date: Oct. 23, 2008

(54) ELECTRONIC APPARATUS AND SYSTEM WITH CONFERENCE CALL SPATIALIZER

(76) Inventor: Linus Akesson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/737,837

(22) Filed: Apr. 20, 2007

(51) Int. Cl. H04M 3/42

(52) U.S. Cl. 379/202.01

(57) ABSTRACT

A conference call spatializer includes an input for receiving voice data corresponding to each of a plurality of conference call participants. A spatial processor included in the conference call spatializer provides a spatial component to the received voice data to produce multi-channel audio data that, when reproduced, provides a spatial arrangement in which the voice data for each of the plurality of conference call participants appears to originate from different corresponding spatial locations.

### TECHNICAL FIELD OF THE INVENTION

The present invention relates generally to voice communications, and more particularly to an apparatus and system for carrying out multi-party communications, or “conference calls”.

### DESCRIPTION OF THE RELATED ART

Voice communications via telephony have become a fundamental part of everyday life. Whether for business or pleasure, most people have come to rely on telephony to allow them to conduct their daily affairs, keep in contact with each other, carry out business, etc. Moreover, with the increasing development of digital telephony it has become possible to carry out high speed voice and data communications over the internet, within mobile networks, etc.

Multi-party communications, or “conference calls”, have long been available within conventional telephone networks and now within the new high speed digital networks. Conference calls allow multiple parties and multiple locations to participate simultaneously in the same telephone call. Thus, for example, in addition to a standard calling party and receiving party, additional parties may join in the telephone call. Conference calls are particularly useful for carrying on business meetings over the telephone, avoiding the need for each of the parties to meet in person or call each other individually.

Unfortunately, multi-party communications do suffer from some drawbacks. For example, conference calls tend to become confusing when the number of participants grows. A participant may have trouble differentiating between the voices of the other participants. Other than the voice of the participant currently speaking, the participant receives no other indication as to the identity of the speaker. This can be inconvenient in that it causes participants to focus more on determining which party is currently speaking, and less on what is actually being said. Participants find themselves “announcing” their identity prior to speaking in order that the other participants will realize who is speaking.

In view of the aforementioned shortcomings, there is a strong need in the art for an electronic apparatus and system which better enable parties within multi-party communications to differentiate between participants.

### SUMMARY

In accordance with one aspect of the invention, a conference call spatializer is provided comprising an input for receiving voice data corresponding to each of a plurality of conference call participants. The conference call spatializer further includes a spatial processor that provides a spatial component to the received voice data to produce multi-channel audio data that, when reproduced, provides a spatial arrangement in which the voice data for each of the plurality of conference call participants appears to originate from different corresponding spatial locations.

In accordance with another aspect, the conference call spatializer comprises a party positioner for defining the corresponding spatial locations for the conference call participants.

According to yet another aspect, the conference call spatializer comprises spatial gain coefficients corresponding to the spatial locations defined by the party positioner, where the spatial gain coefficients are a function of a virtual distance between the respective spatial locations of the conference call participants and a spatial location of a receiving party to whom the multi-channel audio data is to be reproduced.

In accordance with another embodiment, the conference call spatializer includes spatial gain coefficients which are a function of a virtual distance between the respective spatial locations of the conference call participants and spatial locations of the left ear and right ear of the receiving party.

According to still another aspect, the conference call spatializer includes an offset calculator for adjusting the spatial gain coefficients to account for movement of the head of the receiving party.

In accordance with yet another aspect, the conference call spatializer includes a spatial processor which comprises an array of multipliers. Each multiplier functions to multiply voice data from a corresponding conference call participant by at least one of the spatial gain coefficients to generate left channel voice data and right channel voice data for the corresponding conference call participant.

According to another aspect of the invention, the conference call spatializer further comprises a mixer for adding the left channel voice data and the right channel voice data for each of the corresponding conference call participants to produce the multi-channel audio data.

With still another aspect, the conference call spatializer provides that the received voice data corresponding to each of the conference call participants is monaural.

According to yet another aspect, the conference call spatializer provides that the received voice data corresponding to each of the conference call participants is multi-aural.

In accordance with another aspect, the conference call spatializer requires that the input comprises an audio segmenter for receiving an audio data signal and providing the audio data signal to the spatial processor as discrete voice data channels, with each discrete voice channel data representing a stream of voice data corresponding to a respective one of the conference call participants.

In accordance with still another aspect, the conference call spatializer provides an audio data signal which is packetized audio data that includes voice data for each of the conference call participants in respective fields in each packet.

According to another aspect, the conference call spatializer provides an audio data signal comprising separate channel of audio data with each channel corresponding to a respective conference call participant.

According to still another aspect, the conference call spatializer provides an audio data signal comprising an audio channel including combined voice data for the plurality of conference call participants, and an identifier indicating the conference call participant currently providing dominant voice data.

In accordance with another aspect, a communication device includes a radio transceiver for enabling a user to participate in a conference call by transmitting and receiving audio data, and a conference call spatializer as described above.

In accordance with yet another aspect, the communication device comprises a stereophonic headset for reproducing the multi-channel audio data.

According to another aspect, the communication device includes a party positioner for defining the corresponding spatial locations for the conference call participants. The spatial processor comprises spatial gain coefficients corresponding to the spatial locations defined by the party positioner, the spatial gain coefficients being a function of a virtual distance between the respective spatial locations of the conference call participants and a spatial location of a left and right ear of a receiving party to whom the multi-channel audio data is to be reproduced. The device further comprises positioning means for ascertaining positioning of the stereophonic headset, and provides an offset calculator for adjusting the spatial gain coefficients to account for movement of the head of the receiving party as ascertained by the positioning means.

In accordance with yet another aspect, the communication device provides the communication device is a mobile phone.

With still another aspect, a network server provides a conference call function by receiving voice data from each of the conference call participants and providing the received voice data to each of the other conference call participants. The network server includes conference call spatializer as described above.

With yet another aspect, the network server comprises a party positioner for defining the corresponding spatial locations for the conference call participants.

In still another aspect, the network server provides a spatial processor comprising spatial gain coefficients corresponding to the spatial locations defined by the party positioner, the spatial gain coefficients being a function of a virtual distance between the respective spatial locations of the conference call participants and a spatial location of a receiving party to whom the multi-channel audio data is to be reproduced.

In accordance with another aspect, the spatial gain coefficients are a function of a virtual distance between the respective spatial locations of the conference call participants and spatial locations of the left ear and right ear of the receiving party.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic diagram representing the spatial locations of participants in a conference call in accordance with an embodiment of the present invention;

FIG. 2 is a schematic diagram illustrating an offset which occurs as a result of rotation of a participant's head in accordance with an embodiment of the present invention;

FIG. 3 is a table representing party positions based on number of participants in accordance with an embodiment of the present invention;

FIG. 4 is a table representing spatial gain coefficients based on party position in accordance with the present invention;

FIG. 5 is a functional block diagram of a conference call spatializer in accordance with an embodiment of the present invention;

FIG. 6 is a schematic diagram of a spatial processor included in the conference call spatializer in accordance with an embodiment of the present invention;

FIG. 7 is a functional block diagram of a mobile phone incorporating a conference call spatializer in accordance with an embodiment of the present invention;

FIG. 8 is a perspective view of the mobile phone of FIG. 7 in accordance with an embodiment of the present invention;

FIG. 9 is a schematic diagram of a packet of multi-party voice data in accordance with an embodiment of the present invention;

FIG. 10 is a schematic diagram of discrete channels of voice data in accordance with an embodiment of the present invention;

FIG. 11 is a schematic diagram of combined voice data with a dominant party identifier in accordance with an embodiment of the present invention; and

FIG. 12 is a functional block diagram of a network conference call server incorporating a conference call spatializer in accordance with an embodiment of the present invention.

### DETAILED DESCRIPTION OF EMBODIMENTS

The present invention will now be described in relation to the drawings, in which like reference numerals are used to refer to like elements throughout.

The present invention takes advantage of cognitive feedback provided by the spatial locations of participants in a meeting. During actual “in-person” conference meetings, the location from which a participant speaks provides the listening participant or party with information as to the identity of the speaker even if the listening party is unable to see the speaker. For example, if a meeting participant is turned away from the speaker but knows the speaker is located over his or her left shoulder, it is easier for the participant to recognize the identity of the speaker. Whether it be subconsciously or not, a listener begins to associate a voice coming from a particular location in the meeting as belonging to the participant at such location. Thus, not only the sound of the voice identifies the speaker, but also the location from which the voice originates.

According to the present invention, a spatial arrangement including each of the participants in a conference call is provided in virtual space. Using multi-channel audio imaging, such as stereo imaging, voice data during the conference call is presented to a listening participant such that the voice of the speaking party at any given time appears to originate from a corresponding spatial location of the speaking party within the spatial arrangement. In such manner, the voice of each of the participants in the conference call appears to originate from a corresponding spatial location of the participant in virtual space, providing a listening participant with important cognitive feedback in addition to the voice of the speaking party itself.

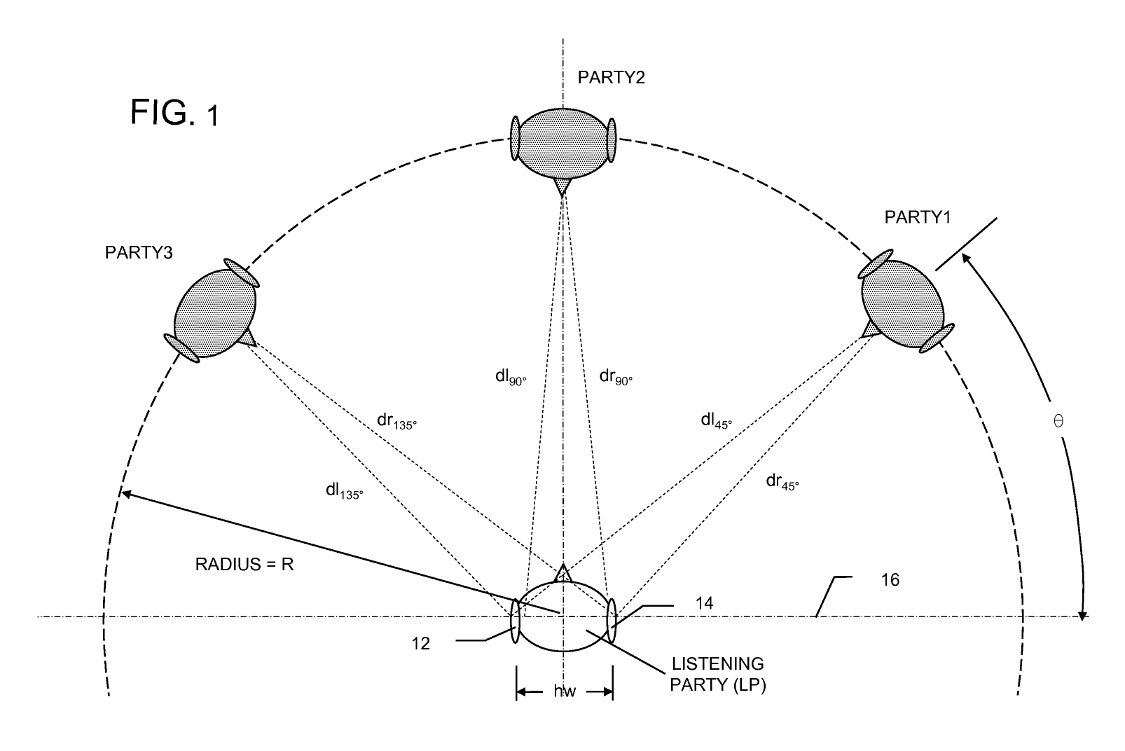

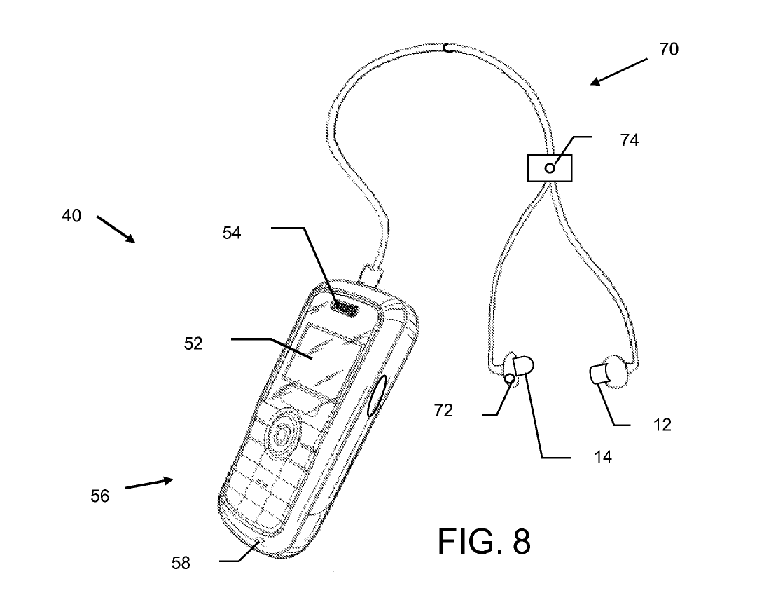

Referring initially to FIG. 1, a schematic representation of a conference call occurring in virtual space is illustrated. In accordance with the exemplary embodiment of the present invention, a listening party LP takes part in a conference call using generally conventional telephony equipment except as described herein. The listening party LP utilizes a multichannel headset or other multichannel audio reproduction arrangement (e.g., multiple audio speakers positioned around the listening party LP). In the exemplary embodiment, the listening party LP utilizes a stereo headset coupled to a mobile phone as is discussed in more detail below in relation to FIG. 8.

The stereo headset includes a left speaker 12 for reproducing left channel audio sound into the left ear of the listening party LP, and a right speaker 14 for reproducing right channel audio sound into the right ear of the listening party LP. The left speaker 12 and the right speaker 14 are separated from one another by a distance hw corresponding to the headwidth or distance between the ears of the listening party LP. For purposes of explanation of the present invention, the distance hw is assumed to be the average headwidth of an adult, for example.

In the example illustrated in FIG. 1, it is assumed that the listening party LP is participating in a conference call involving three additional participants, namely Party 1, Party 2 and Party 3. As is explained in more detail below in relation to FIG. 3, the participants Party 1 thru Party 3 are arranged in virtual space in relation to the listening party LP such that sound (e.g., voice) originating from the respective participants appears to originate from different corresponding spatial locations from the perspective of the listening party LP. In the present example, the participants Party 1 thru Party 3 are positioned so at to be equally spaced from one another in a semicircle of radius R originating from the listening party LP as illustrated in FIG. 1.

Thus, for example, Party 1 thru Party 3 are equally positioned at angles θ=45°, 90° and 135°, respectively, from an axis 16. The axis 16 represents an axis extending through the center of each ear of the listening party LP in accordance with an initial angular orientation of the head of the listening party LP. The radius R can be any value, but preferably is selected so as to represent a comfortable physical spacing between participants in an actual “in-person” conversation. For example, the radius R may be preselected to be 1.0 meter, but could be any other value as will be appreciated.

The present invention makes use of spatial imaging techniques of multichannel audio to give the listening party LP the audible impression that participants Party 1 thru Party 3 are literally spaced at angles θ=45°, 90° and 135°, respectively, in relation to the listening party LP. Such spatial imaging techniques are based on the virtual distances of the party currently speaking and the left and right ears of the listening party LP. For example, the virtual distance between the left ear of the listening party LP and Party 1 can be represented by dl₄₅°. Similarly, the virtual distance between the right ear of the listening party LP and Party 1 can be represented by dr₄₅°. Likewise, the distances between the left and right ears of the listening party LP and Party 2 can be represented by dl_{90° and dr}₉₀°, respectively. The distances between the left and right ears of the listening party LP and Party 3 can be represented by dl₁₃₅° and dr₁₃₅°, respectively. Applying basic and well known trigonometric principles, each of the distances dl and dr corresponding to the participants Party 1 thru Party 3 can be determined easily based on a predefined radius R and headwidth hw.

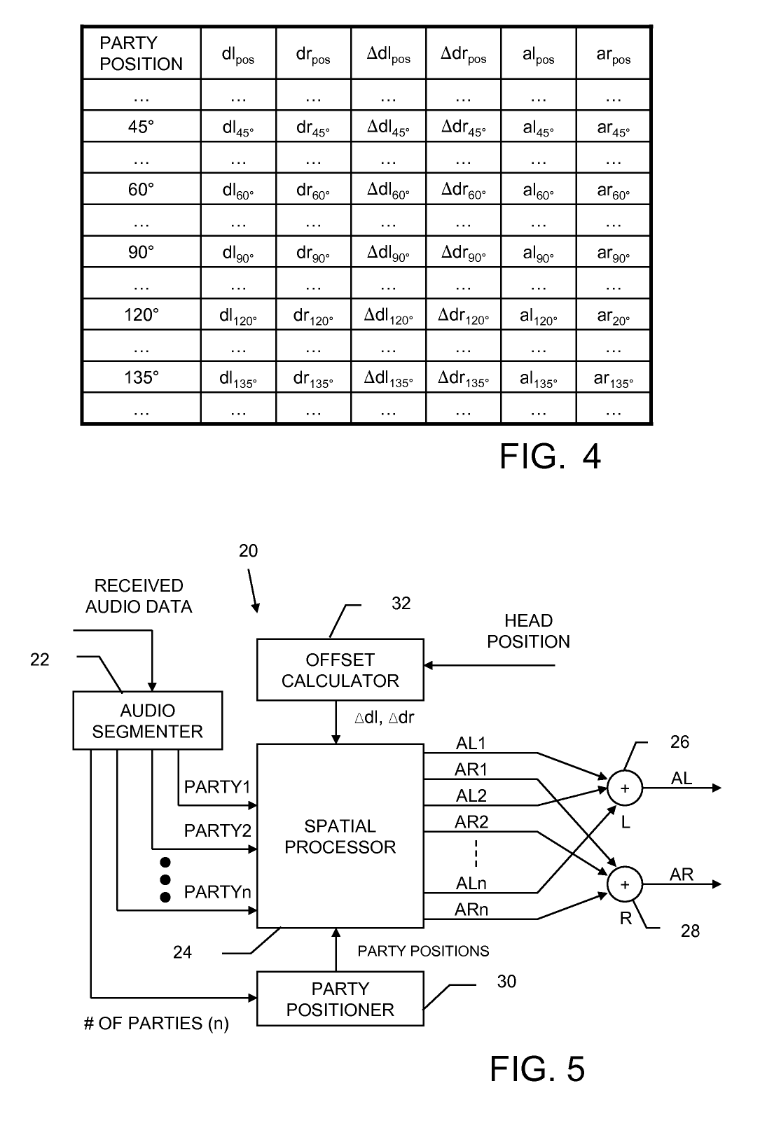

As is discussed below in relation to FIG. 4, the distances dl and dr corresponding to each of the participants Party 1 thru Party 3 are used to determine spatial gain coefficients applied to the voice data of the respective participants in order that the voice data reproduced to the left and right ears of the listening party LP images the spatial locations of the participants to correspond to the positions shown in FIG. 1. In this manner, the listening party LP is provided audibly with a sensation that the actual physical positions of the participants Party 1 thru Party 3 correspond to that shown in FIG. 1. Such sensation enables the listening party LP to differentiate more easily between the particular participants Party 1 thru Party 3 during a conference call, and particularly to differentiate between whom is speaking at any given time.

Although FIG. 1 illustrates an example involving three participants (in addition to the listening party LP), it will be appreciated that any number of participants can be accommodated using the same principles of the invention. Furthermore, although the participants are spatially arranged so as to be equally spaced in a semicircle at radius R, it will be appreciated that the participants may be spatially located in virtual space essentially anywhere in relation to the listening party LP, including behind the listening party LP and/or at different radii R. The present invention is not limited to any particular spatial arrangement in its broadest sense. Still further, although the present invention is described primarily in the context of the listening party LP utilizing a headset providing left and right audio channels, the present invention could instead employ left and right stand alone audio speakers. Moreover, multi-channel 5.1, 7.1, etc., audio formats may be used rather than simple two-channel audio without departing from the scope of the invention. Spatial imaging is provided in the same manner except over additional audio reproduction channels as is well known. In addition, it will be appreciated that the listening party LP can represent a participant Party 1 thru Party 3 with regard to any of the other participants in the conference call provided any of those other participants utilize the features of the invention. Alternatively, the other participants instead may simply rely on conventional monoaural sound reproduction during the conference call.

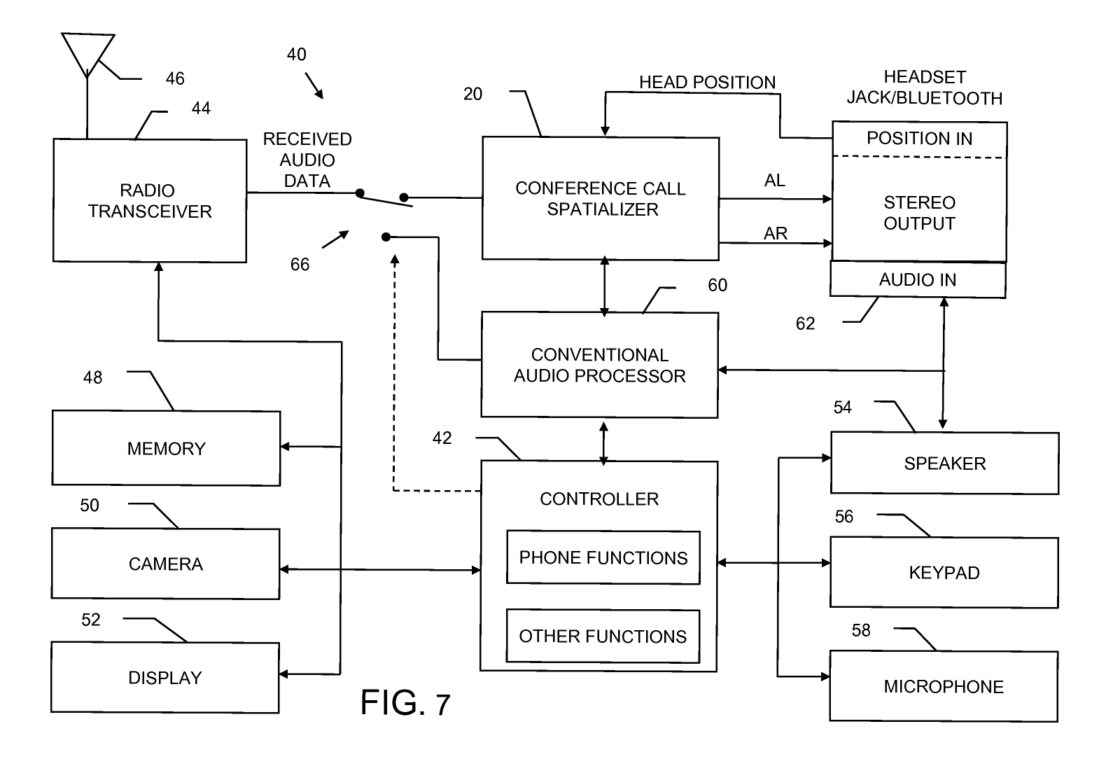

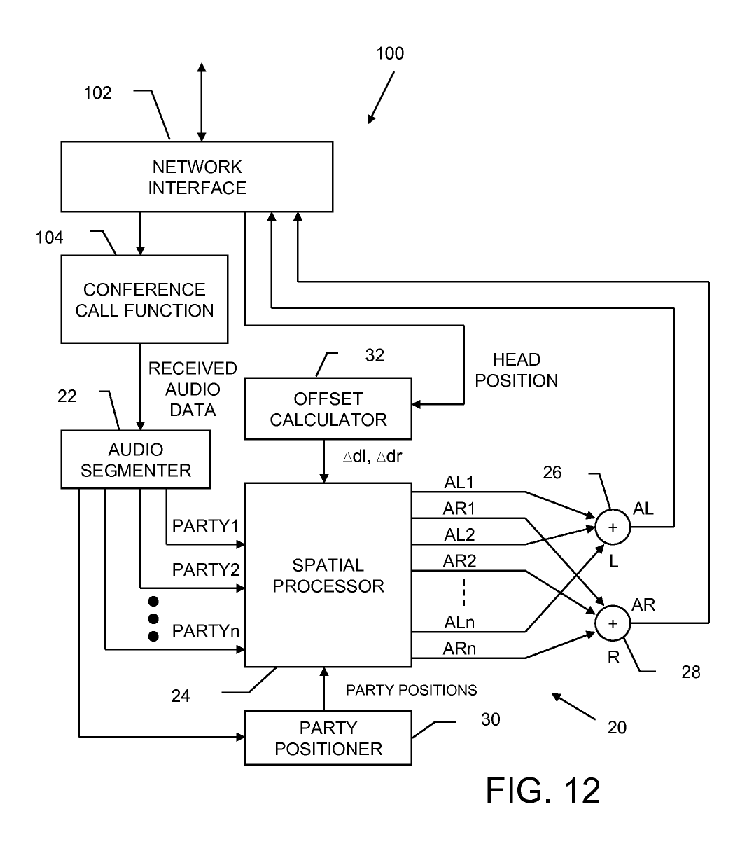

As will be described in more detail below, the particular processing circuitry for carrying out the invention can be located within the mobile phone or other communication device itself. Alternatively, the particular processing circuitry may be included elsewhere, such as in a network server which carries out conventional conference call functions in a telephone network. FIG. 7 discussed below relates to a mobile phone that incorporates such processing circuitry. FIG. 12 discussed below refers to a network server that incorporates such processing circuitry.

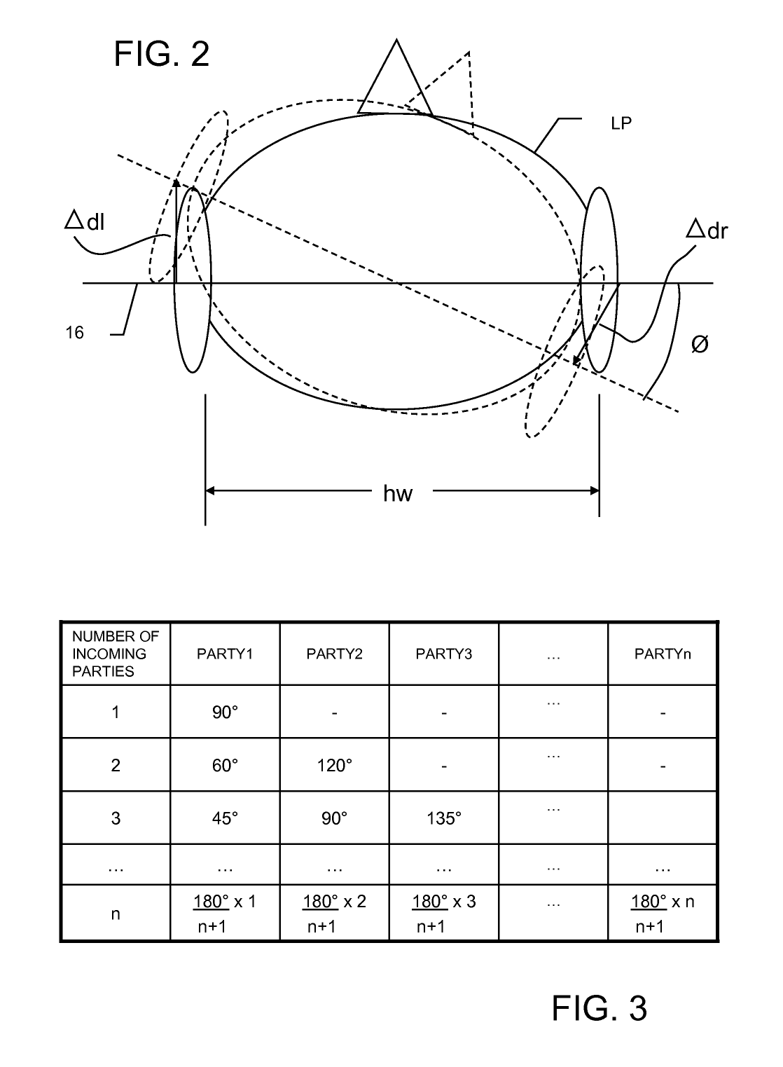

Referring to FIG. 2, an aspect of the present invention takes into account an offset in the distances dl and dh between the listening party LP and the other conference call participants based on rotation or other movement of the head of the listening party. For example, if the listening party LP physically turns his or her head during a conference call, the present invention can adjust the spatial position of the participants Party 1 thru Party 3 as perceived by the listening party LP such that the spatial positions appear to remain constant. Thus, referring to FIG. 1, initially the listening party LP may directly face Party 2 as shown in virtual space. Parties 1 and 3 will appear to the listening party LP as being positioned to his or her right and left side, respectively. However, should the listening party LP then rotate his or her head by an angle φ relative to the initial axis 16 as represented in FIG. 2, the listening party LP ordinarily would then be facing towards another participant, e.g., Party 1. In such case, Parties 2 and 3 would then be located to the left of the listening party LP as perceived in the spatial arrangement presented to the listening party LP.

According to an exemplary embodiment, an accelerometer is included within the headset of the listening party LP. Based on the output of the accelerometer, the angle φ which the listening party LP rotates his or her head can be determined. In accordance with a simplified implementation and again using basic trigonometric principles, a change in position of the left and right ears of the listening party, designated Δdl and Δdr, respectively, can be determined. These changes in position can be used as offsets to the distances dl and dr discussed above in relation to FIG. 1 in order to adjust the spatial gain coefficients applied to the voice data. This gives the listening party LP the perception that the positions of the participants Party 1 thru Party 3 remain stationary despite rotation of the head of the listening party LP. In another embodiment, more complex geometric computations, still readily known in the art, can be used to determine the precise location of the left and right ears of the listening party relative to the virtual positions of the participants Party 1 thru Party 3, regardless of the particular type of movement of the head of the listening party LP, e.g., simple rotational, translational, vertical, etc. Moreover, the virtual positions of the participants Party 1 thru Party 3 may be changed to give the perception of movement of the participants simply by providing a corresponding change in the values of dl and dr as part of the spatial processing described herein.

Of course, the present invention need not take into account the movement of the head of the listening party LP. In such case, the relative positions of the participants Party 1 thru Party 3 remain the same from the perspective of the listening party LP regardless of head movement. For some users, such operation may be preferable, particularly in the case where the listening party LP is in an environment that requires significant head movement unrelated to the conference call.

FIG. 3 represents a look-up table suitable for use in the present invention for determining equally spaced angular positions of the participants Party 1 thru Party n (relative to the listening party LP as exemplified in FIG. 1). The angular position θ of each of the participants may be defined by the equation:

θ_{Party i}=(180°·i)/(n+1), where i=1 to n (Equ. 1)

where n equals the number of participants (e.g., Party 1 thru Party n) involved in the conference call (in addition to the listening party LP).

Thus, as indicated in FIG. 3, in the case of two participants (n=2), Party 1 and Party 2 are located at θ=60° and 90°, respectively, relative to the listening party LP. In the case of three participants (n=3) as represented in FIG. 1, Party 1 thru Party 3 are located at θ=45°, 90° and 135°, respectively, relative to the listening party LP.

FIG. 4 represents a look-up table suitable for use in the present invention for determining the spatial gain coefficients al and ar in accordance with the particular positions of the participants Party 1 thru Party n. For a given party position, e.g., a participant located at θ=45° such as Party 1 in FIG. 1, the participant will be located at a virtual distance dl₄₅° from the left ear of the listening party LP, and a virtual distance dr₄₅° from the right ear of the listening party LP as discussed above. Moreover, in an embodiment which takes into account rotation of the head of the listening party LP as discussed above in relation to FIG. 2, the distances between the participant located at θ=45° and the left and right ears of the listening party LP will be subject, for example, to respective offsets Δdl and Δdr as discussed above. Based on such entries in the table, the table includes spatial gain coefficient entries for the left and right audio channels provided to the left and right ears of the listening party LP used to image the respective participants at their respective locations.

As will be appreciated, the left and right spatial gain coefficients (designated al and ar, respectively) are utilized to adjust the amplitude of the voice data from a given participant as reproduced to the left and right ears of the listening party LP. By adjusting the amplitude of the voice data reproduced in the respective ears, the voice data is perceived by the listening party LP as originating from the corresponding spatial location of the participant. Such spatial gain coefficients al and ar for a given spatial location may be represented by the following equations:

al=(e^{-(dr+Δdr)}/(e^{-(dl+Δdl)}+e^{-(dr+Δdr)}) (Equ. 2)

ar=(e^{-(dl+Δdl)})/(e^{-(dl+Δdl)}+e^{-(dr+Δdr)}) (Equ. 3)

As will be appreciated, the spatial gain coefficients al and ar take into account the difference in amplitude between the voice data as perceived by the left and right ears of the listening party LP due to the difference in distances dl and dr from which the voice sound must travel from a given participant to the left and right ears of the listening party LP in the case where the speaking party is not positioned directly in front of the listening party LP. Referring to FIG. 1, for example, the gain coefficients al_{90°} and ar_{90°} for Party 2 at position θ=90° will be equal since distances dl₉₀° and dr₉₀° will be equal. In the case of Party 1 at position θ=45°, on the other hand, spatial gain coefficient ar₄₅° will be greater than gain coefficient al₄₅° due to distance dl₄₅° being greater than distance dr₄₅°.

Furthermore, it will be appreciated that in an embodiment that does not take into account offsets Δdl and Δdr based on movement of the listening party LP, such terms in Equ. 2 and Equ. 3 are simply set to zero.

Use of the look-up tables in FIGS. 3 and 4 for obtaining the corresponding positions and spatial gain coefficients of the participants in the conference call avoids the need for processing circuitry to compute such positions and spatial gain coefficients in real time. This reduces the necessary computational overhead of the processing circuitry. However, it will be appreciated that the positions and spatial gain coefficients in another embodiment can easily be calculated by the processing circuitry in real time using the principles described above.

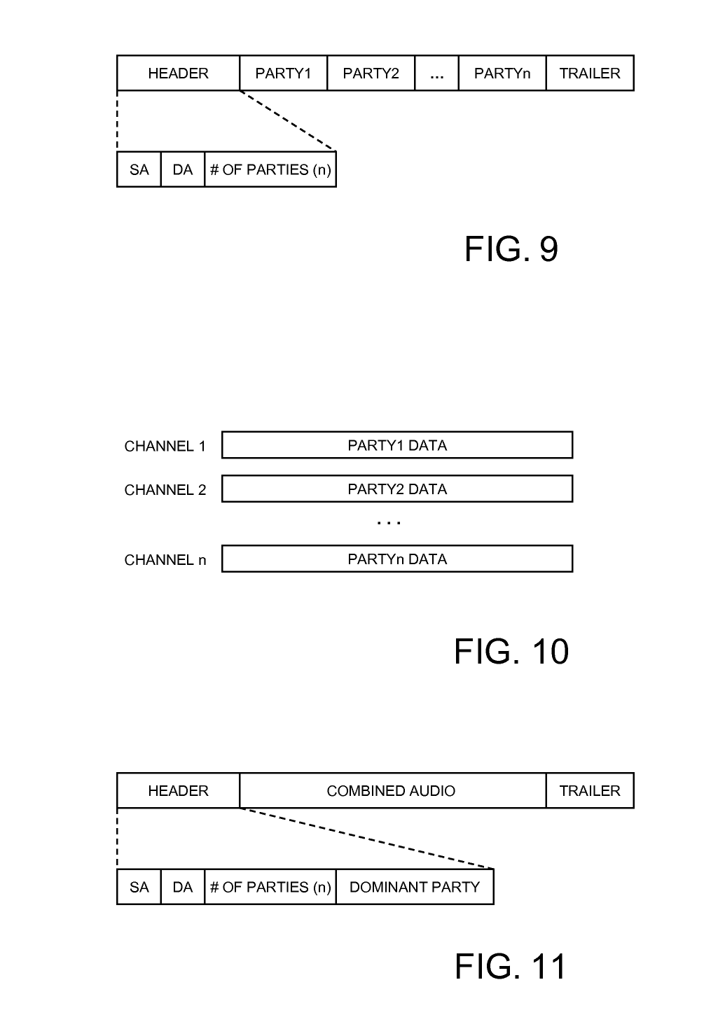

FIG. 5 is a functional block diagram of a conference call spatializer 20 for carrying out the processing and operations described above in order to provide spatial positioning of the conference call participants according to the exemplary embodiment of the invention. The spatializer 20 includes an audio segmenter 22 which receives audio data intended for the listening party LP from the conference call participants (e.g., Party 1 thru Party 3). As is explained in more detail below with respect to FIGS. 9-11, the audio data received by the audio segmenter 22 includes audio data (e.g., voice) from each of the respective conference call participants together with information relating to which audio data corresponds to which particular participant. In addition, the audio data may include information relating to the total number of participants in the conference call (in addition to the listening party LP).

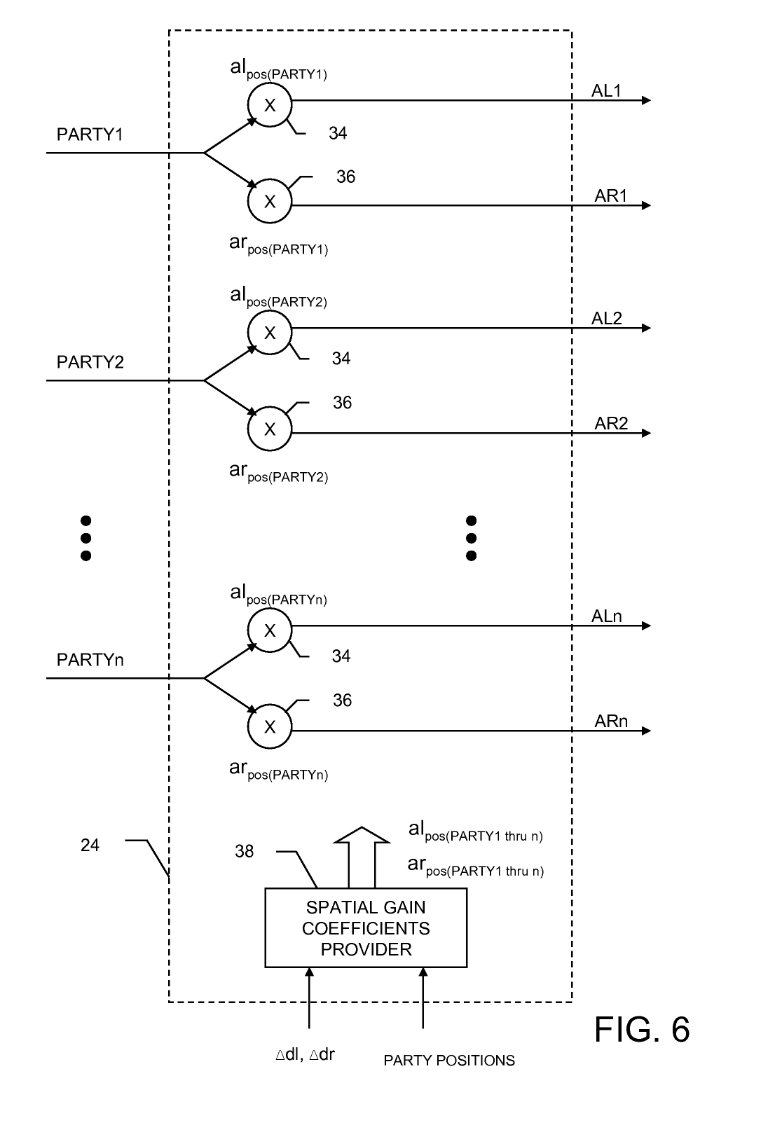

The audio segmenter 22 parses the audio data received from the respective participants (e.g., Party 1 thru Party n) to the extent necessary, and provides the audio data in respective data streams to a spatial processor 24 also included in the spatializer 20. As is discussed below in connection FIG. 6, the spatial processor 24 carries out the appropriate processing of the voice data from the respective participants in order to provide the respective imaging for the corresponding spatial locations in accordance with the principles described above. The spatial processor 24 in turn outputs audio (e.g., voice data) for each of the respective participants in the form of left and right audio data (e.g., AL1 to ALn, and AR1 to ARn). The left channel audio data AL1 to ALn from the corresponding participants is input to a left channel mixer 26 included in the spatial processor 24 to produce an overall left channel audio signal AL. Similarly, the right channel audio data AR1 to ARn from the corresponding participants is input to a right channel mixer 28 included in the spatial processor 24 to produce an overall right channel audio signal AR. The overall left and right channel audio signals AL and AR are then output by the spatial processor 24 and provided to the left and right speakers 12 and 14 of the listening party LP headset (FIG. 1), respectively, in order to be reproduced.

The spatial processor 24 further includes a party positioner 30 that provides spatial position information for the respective conference call participants to the spatial processor 24. The party positioner 30 may be based simply on the look-up table exemplified in FIG. 3. The party positioner 30 receives as an input from the audio segmenter 22 an indication of the number of parties participating in the conference call (other than the listening party LP). Based on such input, the corresponding party positions are assigned to the participants based on the party positions obtained from the look-up table of FIG. 3. In another embodiment, the party positioner 30 may be configured to calculate such positions in real time based on Equ. 1 discussed above. The party positioner 30 in turn provides the party position information to the spatial processor 24.

The spatial processor 24 also includes an offset calculator 32 for determining the respective offsets Δdl and Δdr in an embodiment that utilizes such offsets. The offset calculator 32 is configured to receive information from an accelerometer included in the headset of the listening party LP and to calculate the respective offsets based thereon. The offset calculator 32 in turn provides the respective offsets for each participant in relation to their corresponding spatial position (as provided by the party positioner 30, for example), to the spatial processor 24. Specific techniques for calculating such movement offsets based on the information from an accelerometer are well known. Accordingly, the specific techniques used in the offset calculator 32 are not germane to the present invention, and hence additional detail has been omitted for sake of brevity.

Referring now to FIG. 6, an exemplary configuration of the spatial processor 24 is shown. The spatial processor 24 includes a left channel multiplier 34 and right channel multiplier 36 pair for each particular participant (i.e., Party 1 thru Party n). The voice data as provided from the audio segmenter 22 (FIG. 5) for each particular participant is input to the respective left channel multiplier 34 and right channel multiplier 36 pair. It will be appreciated that the voice data for each participant will typically be single-channel or monaural audio. However, the present invention also has utility when the voice data from a participant is multi-channel, for example stereophonic. In the example of FIG. 6, the voice data for each participant is monaural, and thus the same audio data is input to both the left channel multiplier 34 and the right channel multiplier 36 for that particular participant.

The left channel multiplier 34 and the right channel multiplier 36 for each respective conference call participant multiplies the voice data from that participant by the corresponding spatial gain coefficients al and ar, respectively. In the exemplary embodiment, the corresponding spatial gain coefficients al and ar are provided by a spatial gain coefficients provider 38 included in the spatial processor 24. The spatial gain coefficients provider 38 may be based simply on the spatial gain coefficient look-up table discussed above in relation to FIG. 4. For example, the offsets from the offset calculator 32 and the party positions from the party positioner 30 are input to the spatial gain coefficients provider 38. The spatial gain coefficients provider 38 in turn accesses the corresponding spatial gain coefficient entries al and ar from the spatial gain coefficient look-up table. The spatial gain coefficients provider 38 proceeds to provide the corresponding spatial gain coefficients to the left and right channel multipliers 34 and 36 for the respective conference call participants.

The spatial processor 24 thus provides the appropriate adjustment in the amplitude of the thereby created left and right channel signals AL_{1 to n} and AR_{1 to n}. By virtue of such adjustment in amplitude, the left and right channel audio provided by the respective participants will result in the voice data from the participants being imaged so as to appear to originate from their corresponding spatial position as described above.

FIG. 7 is a functional block diagram of a mobile phone 40 of a listening party LP incorporating a conference call spatializer 20 in accordance with the present invention. The mobile phone 40 includes a controller 42 configured to carry out conventional phone functions as well as other functions as described herein. In addition, the mobile phone 40 includes a radio transceiver 44 and antenna 46 as is conventional for communicating within a wireless phone network. In particular, the radio transceiver 44 is operative to receive voice data from one or more parties at the other ends of a telephone call(s), and to transmit voice data of the listening party LP to the other parties in order to permit the listening party LP to carry out a conversation with the one or more other parties.

Furthermore, the mobile phone 40 includes conventional elements such as a memory 48 for storing application programs, operational code, user data, etc. Such conventional elements may further include a camera 50, user display 52, speaker 54, keypad 56 and microphone 58. The mobile phone 40 further includes a conventional audio processor 60 for performing conventional audio processing of the voice data in accordance with conventional telephone communications.

In connection with the particular aspects of the present invention, the mobile phone 40 includes a headset adaptor 62 for enabling the listening party LP to connect a headset with speakers 12 and 14 (FIG. 1), or other multi-channel audio reproduction equipment, to the mobile phone 40. In the case where the listening party LP utilizes a wired headset, the headset adaptor 62 may simply represent a multi-terminal jack into which the headset may be connected via a mating connector (not shown). Alternatively, the headset may be wireless, e.g., a Bluetooth headset with multi-channel audio reproduction capabilities. In such case, the headset adaptor 62 may be a corresponding wireless interface (e.g., Bluetooth transceiver).

The headset adaptor 62 in the exemplary embodiment includes a stereo output to which the combined left and right channel audio signals AL and AR from the conference call spatializer 20 are provided. In such manner, the combined left and right channel audio signals AL and AR from the conference call spatializer 20 are provided to the corresponding left and right speakers 12, 14 of the listening party headset connected to the headset adaptor 62. Additionally, in the case of conventional audio operation, the conventional audio signal may be provided to the headset adaptor 62 from the conventional audio processor 60, as will be appreciated.

The headset adaptor 62 further includes a position signal input for receiving a signal from an accelerometer included in the headset of the listening party LP. The signal represents the head position signal that is input to the offset calculator 32 within the conference call spatializer 20 as described above in relation to FIG. 5. Finally, the headset adaptor 62 includes an audio input for receiving voice data from the headset of the listening party LP that is in turn transmitted to the party or parties at the other end of the telephone call(s) via the conventional audio processor 60 and the transceiver 44.

In accordance with the exemplary embodiment, the listening party LP may select conference call spatialization via the conference call spatializer 20 by way of a corresponding input in the keypad or other user input. Based on whether the listening party LP selects conference call spatialization in accordance with the present invention, the controller 42 is configured to control a switch 66 that determines whether conference call voice data received via the transceiver 44 is processed conventionally by the audio processor 60, or via the conference call spatializer 20. In accordance with another embodiment, the controller 42 is configured to detect whether the voice data received by the transceiver 44 is in an appropriate data format for conference call spatialization as exemplified below in relation to FIGS. 9-11. If the controller 42 detects that the voice data is in appropriate format, the controller 42 may be configured to automatically cause the switch 66 to provide processing by the conference call spatializer 20.

It will be appreciated that the various operations and functions described herein in relation to the present invention may be carried by discrete functional elements as represented in the figures, substantially via software running on a microprocessor, or a combination thereof. Furthermore, the present invention may be carried out using primarily analog audio processing, digital audio processing, or any combination thereof. Those having ordinary skill in the art will appreciate that the present invention is not limited to any particular implementation in its broadest sense.

Referring briefly to FIG. 8, shown is a perspective view of the mobile phone 40 of FIG. 7. As illustrated, a headset 70 of the listening party LP may be a wired headset connected to the headset adaptor 62 of the mobile phone 40. The headset 70 includes the left speaker 12 and right speaker 14 to be positioned adjacent the left and right ears of the listening party LP, respectively. The left speaker 12 and the right speaker 14 in turn reproduce the combined left and right channel audio signals AL and AR, respectively, as described above. In addition, the headset 70 includes one or more accelerometers 72 for providing the above described head position input to the conference call spatializer 20. Still further, the headset 70 includes a microphone 74 for providing the audio input signal to the headset adaptor 62, representing the voice of the listening party LP during a telephone call.

As previously noted, the voice data for the respective conference call participants as received by the conference call spatializer 20 preferably is separable into voice data for each particular participant. There are several ways of carrying out such separation. Accordingly, only a few will be described herein.

For example, FIG. 9 illustrates a packet format of multi-party voice data received by the listening party LP conference call spatializer. The network server (not shown) or other device responsible for enabling the conference call between the listening party LP and other conference call participants is configured to receive the voice data from the other conference call participants and package the voice data in accordance with the format shown in FIG. 9. The network server or other device then transmits the voice data in such format to the mobile phone 40 or other device incorporating the conference call spatializer 20 in accordance with the present invention.

As is shown in FIG. 9, each packet of voice data contains a header and trailer as shown. Included in the packet payload is separate voice data in respective fields for each of the parties Party 1 thru Party n participating in the conference call (in addition to the listening party LP). The voice data for each party as included in a given packet may represent a predefined time unit of voice data, with subsequent packets carrying subsequent units of voice data as is conventional.

The header, as is conventional, includes source address (SA) and destination address (DA) information identifying the address of the network server, for example, as the source address SA, and the network address of the mobile phone of the listening party LP as the destination address DA. In addition, however, the header preferably includes information regarding the number of parties (n) participating in the conference call (in addition to the listening party LP).

The audio segmenter 22 discussed above in relation to FIG. 5 receives such audio packets and is configured to separate the voice data of the respective conference call participants and provide the corresponding individual streams of voice data to the spatial processor 24. Moreover, the audio segmenter 22 may provide the information (n) from the header (indicating the number of participants) to the party positioner 30 as described above. The conference call spatializer 20 can then process the voice data for reproduction to the listening party LP in accordance with the above described operation.

In a different embodiment, the audio segmenter 22 may be configured to detect automatically the number (n) of conference call participants simply by analyzing the number of voice data fields included in a package. In such case, the header need not include such specific information.

FIG. 10 illustrates an alternative embodiment in which the voice data of the respective conference call participants is provided by the network server or other device in the form of discrete channels of voice data. Each channel corresponds to a respective participant Party 1 thru Party n. The audio segmenter 22 (FIG. 5) receives the multiple channels of voice data and provides the data to the corresponding input of the spatial processor 24. In addition, the audio segmenter 22 is configured to detect the number of channels of voice data, and hence the number of conference call participants, and provides such number to the party positioner 30. Again, the conference call spatializer 20 can then process the voice data for reproduction to the listening party LP in accordance with the above described operation.

FIG. 11 represents a slightly different approach to receiving and processing the voice as compared to FIGS. 9 and 10. The approach of FIG. 11 relies on the network server or other device controlling the conference call and providing the voice data to the listening party LP to provide an indication of which particular party is the dominant speaker at any given time. For example, the network server or other device receives voice data individually from each party participating in the conference call. According to the embodiment of FIG. 11, at any given moment in time, the network server or other device analyzes the voice data from each of the respective parties and determines which particular party is speaking the loudest and/or most continuous, etc. In addition, the network server or other device forms a combined audio signal including the voice data from each of the parties mixed together. The network server or other device then transmits a packet including such information to the listening party LP.

Thus, an exemplary packet of voice data as represented in FIG. 11 includes a header which again has a source address SA, destination address DA, and number of conference call participants (in addition to the listening party LP), similar to the embodiment of FIG. 9. In addition, however, the header includes information identifying the dominant party whom is speaking with respect to the combined audio included in the payload of the packet. Such combined audio data is provided to the audio segmenter 22. In this particular embodiment, the audio segmenter 22 simply provides the combined audio data included in the payload to only the input of the spatial processor 24 corresponding to the conference call participant identified in the incoming packet as being the dominant party. Thus, the combined audio data is reproduced to the listening party as so as to originate only from the spatial location corresponding to the dominant party.

According to a variation of the approach shown in FIG. 11, the information regarding the dominant party and/or number of parties can be provided via a separate, low bandwidth channel also connected to the mobile phone of the listening party LP. Thus, a conventional audio packet format can be used to transmit the combined audio.

It will be appreciated that the amount of audio data and/or the necessary bandwidth for transmitting the audio data to the conference call spatial processor 20 will depend largely on the particular approach. For example, the multi-channel techniques represented by FIGS. 9 and 10 will require more bandwidth than the approach of FIG. 11. However, with the latest generations of mobile networking, sufficient bandwidth is readily available for use in accordance with the present invention. On the other hand, in the case of FIG. 11 very little additional bandwidth is required compared to conventional communications as will be appreciated.

Turning now to FIG. 12, another embodiment of the present invention is shown. In this embodiment, the conference call spatializer 20 is included within a network conference call server 100 as opposed to the mobile phone or other device of the listening party LP as in FIG. 7. In this embodiment, the network conference call server 100 carries out the spatial processing described herein, and simply provides the corresponding overall left and right channel audio signals AL and AR to the mobile phone or other communication device of the listening party LP. In fact, the network conference call server 100 can be configured to carry out similar operation with respect to each of the participants in the conference call. All that is necessary is that the mobile phone or other communication device of the participant be capable of receiving and reproducing multi-channel (e.g., stereo) audio. In this manner, the requisite computational processing capabilities can be provided in the network conference call server 100. Such capabilities are not necessary in the mobile phone or other communication device, thereby avoiding any increased costs with respect to the mobile phones or other communication devices.

With respect to a given listening party LP from among the conference call participants, the network conference call server 100 includes a network interface 102 for coupling the server 100 to a corresponding telephone network. Voice data received from each of the conference call participants (in addition to the listening party LP) is received via the network interface 102 and is provided to a conference call function block 104. The conference call function block 104 carries out conventional conference call functions. In addition, however, the conference call function block 104 provides the voice data from the respective conference call participants to the audio segmenter 22. In this embodiment, the voice data provided to the audio segmenter 22 may simply be the voice data of the respective participants (e.g., discrete channels). In other words, it is not necessary to packetize the voice data for transmission to the audio segmenter 22. Additionally, the conference call function block 104 provides information to the audio segmenter 22 indicating the number of conference call participants (in addition to the listening party LP).

The conference call spatializer 20 operates in the same manner described above to produce the overall left and right channel audio signals AL and AR. These signals are then transmitted to the listening party LP via the network interface 102 for reproduction by the mobile phone or other communication device used by the listening party LP. In an embodiment in which the movement of the listening party LP is taken into account to produce offsets Δdl and Δdr as discussed above, head position data measured by an accelerometer or the like can be transmitted by the mobile phone or other communication device of the listening party LP. The network conference call server 100 receives such information via the network interface 102, and provides the information to the offset calculator 32 included in the conference call spatializer 20. Again, then, the conference call spatializer 20 operates in the same manner described above.

Thus, it will be appreciated that the present invention enables the voice of each of the participants in the conference call to appear to originate from the corresponding spatial location of the participant, providing a listening party with important spatial cognitive feedback in addition to simply the voice of the speaking party.

The term “mobile device” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like. While the present invention is described herein primarily in the context of a mobile device, it will be appreciated that the invention has equal applicability to any type of communication device utilized in conference calls. For example, the same principles may be applied to conventional landline telephones, voice-over-internet (VOIP) devices, etc.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A conference call spatializer, comprising:
an input for receiving voice data corresponding to each of a plurality of conference call participants; and
a spatial processor for providing a spatial component to the received voice data to produce multi-channel audio data that, when reproduced, provides a spatial arrangement in which the voice data for each of the plurality of conference call participants appears to originate from different corresponding spatial locations.

2. The conference call spatializer according to claim 1, comprising a party positioner for defining the corresponding spatial locations for the conference call participants.

3. The conference call spatializer according to claim 2, wherein the spatial processor comprises spatial gain coefficients corresponding to the spatial locations defined by the party positioner, the spatial gain coefficients being a function of a virtual distance between the respective spatial locations of the conference call participants and a spatial location of a receiving party to whom the multi-channel audio data is to be reproduced.

4. The conference call spatializer according to claim 3, wherein the spatial gain coefficients are a function of a virtual distance between the respective spatial locations of the conference call participants and spatial locations of the left ear and right ear of the receiving party.

5. The conference call spatializer according to claim 4, comprising an offset calculator for adjusting the spatial gain coefficients to account for movement of the head of the receiving party.

6. The conference call spatializer according to claim 3, wherein the spatial processor comprises an array of multipliers, each multiplier functioning to multiply voice data from a corresponding conference call participant by at least one of the spatial gain coefficients to generate left channel voice data and right channel voice data for the corresponding conference call participant.

7. The conference call spatializer according to claim 6, further comprising a mixer for adding the left channel voice data and the right channel voice data for each of the corresponding conference call participants to produce the multi-channel audio data.

8. The conference call spatializer of claim 1, wherein the received voice data corresponding to each of the conference call participants is monaural.

9. The conference call spatializer of claim 1, wherein the received voice data corresponding to each of the conference call participants is multi-aural.

10. The conference call spatializer of claim 1, wherein the input comprises an audio segmenter for receiving an audio data signal and providing the audio data signal to the spatial processor as discrete voice data channels, with each discrete voice channel data representing a stream of voice data corresponding to a respective one of the conference call participants.

11. The conference call spatializer of claim 10, wherein audio data signal comprises packetized audio data including voice data for each of the conference call participants in respective fields in each packet.

12. The conference call spatializer of claim 10, wherein the audio data signal comprises separate channels of audio data with each channel corresponding to a respective conference call participant.

13. The conference call spatializer of claim 10, wherein the audio data signal comprises an audio channel including combined voice data for the plurality of conference call participants, and an identifier indicating the conference call participant currently providing dominant voice data.

14. A communication device, comprising:
a radio transceiver for enabling a user to participate in a conference call by transmitting and receiving audio data;
the conference call spatializer of claim 1, wherein audio data received by the radio transceiver during a conference call is input to the conference call spatializer.

15. The communication device of claim 14, comprising a stereophonic headset for reproducing the multi-channel audio data.

16. The communication device of claim 15, comprising:
a party positioner for defining the corresponding spatial locations for the conference call participants,
wherein the spatial processor comprises spatial gain coefficients corresponding to the spatial locations defined by the party positioner, the spatial gain coefficients being a function of a virtual distance between the respective spatial locations of the conference call participants and a spatial location of a left and right ear of a receiving party to whom the multi-channel audio data is to be reproduced; and
further comprising positioning means for ascertaining positioning of the stereophonic headset; and
an offset calculator for adjusting the spatial gain coefficients to account for movement of the head of the receiving party as ascertained by the positioning means.

17. The communication device of claim 14, wherein the communication device is a mobile phone.

18. A network server, comprising:
a conference call function for receiving voice data from each of the conference call participants and providing the received voice data to each of the other conference call participants; and
the conference call spatializer of claim 1, wherein the voice data received from each of the conference call participants serves as the input to the conference call spatializer, and the multi-channel audio data produced by the conference call spatializer represents the received voice data provided to each of the other conference call participants.

19. The network server according to claim 18, comprising a party positioner for defining the corresponding spatial locations for the conference call participants.

20. The network server according to claim 19, wherein the spatial processor comprises spatial gain coefficients corresponding to the spatial locations defined by the party positioner, the spatial gain coefficients being a function of a virtual distance between the respective spatial locations of the conference call participants and a spatial location of a receiving party to whom the multi-channel audio data is to be reproduced.

21. The network server according to claim 20, wherein the spatial gain coefficients are a function of a virtual distance between the respective spatial locations of the conference call participants and spatial locations of the left ear and right ear of the receiving party.
